(19) United States
(12) Patent Application Publication
(10) Pub. No.: US 2026/0107225 A1
(43) Pub. Date: Apr. 16, 2026

(54) PROCESSING METHOD, COMMUNICATION DEVICE, AND STORAGE MEDIUM

(71) Applicant: SHENZHEN TRANSSION HOLDINGS CO., LTD., Shenzhen, Guangdong (CN)

(72) Inventor: Sha WANG, Shenzhen (CN)

(73) Assignee: SHENZHEN TRANSSION HOLDINGS CO., LTD., Shenzhen, Guangdong (CN)

(21) Appl. No.: 19/115,909

(22) PCT Filed: Sep. 28, 2022
(86) PCT No.: PCT/CN2022/122290

§ 371 Date: Mar. 27, 2025

(51) Int. Cl. H04W 52/02; H04W 56/00

(52) U.S. Cl. CPC H04W 52/0229; H04W 56/0015; H04W 56/0045

(57) ABSTRACT

A processing method, a communication device, and a storage medium. The processing method can enable a network device to enter an energy saving state in a case that a first preset condition is met, and specify a specific processing of the network device in the energy saving state, so as to better realize energy saving of the network device. After the network device enters the energy saving state, it can quickly switch the energy saving state of the network device according to the first preset condition or a second preset condition.

### CROSS-REFERENCE TO RELATED APPLICATIONS

This application is a National Stage of International Application No. PCT/CN2022/122290, filed on Sep. 28, 2022, which is hereby incorporated by reference in its entirety.

### TECHNICAL FIELD

The present application relates to communication technology, and in particular, to a processing method, a communication device and a storage medium.

### BACKGROUND

With the improvement of communication technology, a number of various types of communication device is growing, especially the rapid popularization of 5G (5th generation mobile communication technology) NR (new radio) technology. The total energy consumption of 5G is increasing, especially the energy consumption of a network device. Therefore, how to reduce the energy consumption of 5G network device is a technical problem to be solved urgently.

The preceding statements are intended to provide general background information and do not necessarily constitute prior art.

### SUMMARY

The present application provides a processing method, a communication device and a storage medium to solve the technical problem of high energy consumption of 5G network device mentioned above.

A first aspect of the present application provides a processing method that can be applied to a network device (such as a base station, etc.) and includes steps:
S1: in response to meeting a first preset condition, sending first downlink information and entering an energy saving state.

In an embodiment, the meeting the first preset condition, includes at least one of the following:
numbers of user equipments (UEs) camping in all beam directions of the Synchronization Signal Block (SSB) burst set in a target cell are all less than a first target threshold;
numbers of data packets buffered for transmission and/or reception, in all beam directions of the synchronization signal block burst set in the target cell, are all less than a second target threshold, and/or, numbers of data transmission are all less than a third target threshold;
a number of UEs camping in at least one beam direction of the synchronization signal block burst set in the target cell, is less than a fourth target threshold;
a number of data packets buffered for transmission and/or reception, in at least one beam direction of the synchronization signal block burst set in the target cell, is less than a fifth target threshold, and/or, a number of data transmission is less than a sixth target threshold.

In an embodiment, the energy saving state, includes at least one of the following:
a transmission period of at least one synchronization signal block in a synchronization signal block burst set of a target cell is increased to a target period, and the transmission period of at least one synchronization signal block in the synchronization signal block burst set of the target cell is unchanged;
at least one synchronization signal block in the synchronization signal block burst set of the target cell is suspended and the transmission period of at least one synchronization signal block in the synchronization signal block burst set of the target cell is unchanged;
all synchronization signal blocks in the synchronization signal block burst set of the target cell are suspended;
transmission periods of all synchronization signal blocks in the synchronization signal block burst set of the target cell are increased to a target period.

In an embodiment, the first downlink information includes at least one of the following:
an energy indicator field for indicating an energy consumption state of the target cell;
a period field for indicating a transmission period of at least one synchronization signal block of the target cell;
a synchronization signal block index field for indicating a synchronization signal block index of the target cell.

In an embodiment, a number of a first bit occupied by the synchronization signal block index field is equal to a number of a second bit set to 1 in an SSB-PositionsInBurst parameter.

In an embodiment, after the step S1, further including steps:
S2: receiving an uplink wake-up signal, the uplink wake-up signal is used for determining a number of user equipments camping in at least one beam direction of the synchronization signal block burst set in the target cell.

In an embodiment, the uplink wake-up signal includes at least one of the following:
a UE identification;
a specific synchronization signal block index;
a specific synchronization signal block period;
a preamble sequence;
a tracking reference signal sequence;
a demodulation reference signal-like sequence carried on a physical uplink shared channel.

In an embodiment, after step S2, further including steps:
S3: in response to meeting a second preset condition, sending second downlink information and entering a normal state.

In an embodiment, the meeting the second preset condition, includes at least one of the following:
numbers of user equipments camping in all beam directions of the synchronization signal block burst set in the target cell are all greater than or equal to the first target threshold;
numbers of data packets buffered for transmission and/or reception, in all beam directions of the synchronization signal block (SSB) burst set in the target cell, are all greater than or equal to the second target threshold, and/or, numbers of data transmission are all greater than or equal to the third target threshold;
a number of user equipments camping in at least one beam direction of the synchronization signal block burst set in the target cell, is greater than or equal to the fourth target threshold;
a number of data packets buffered for transmission and/or reception, in at least one beam direction of the synchronization signal block burst set in the target cell, is greater than or equal to the fifth target threshold, and/or, the number of data transmission is greater than or equal to the sixth target threshold.

In an embodiment, the entering the normal state, includes at least one of the following:
a transmission period of at least one synchronization signal block with bit set to 1 in target cell's SSB-PositionsInBurst parameter is consistent with a period configured by ssb-periodServingCell;
transmission periods of all the synchronization signal blocks with bit set to 1 in the target cell's SSB-PositionsInBurst parameter are consistent with a period configured by the ssb-periodServingCell.

In an embodiment, the target cell includes at least one of the following:
in carrier aggregation, a secondary cell whose Time Advance (TA) value resides within the same Time Advance Group (TAG) as those of a primary cell;
in the carrier aggregation, a secondary cell corresponding to a micro base station whose distance from a primary cell corresponding to a macro base station is less than a seventh target threshold;
a component carrier that does not carry downlink control information during cross-carrier scheduling in carrier aggregation;
a component carrier where the downlink control information resides during self-scheduling.

In a second aspect, the present application provides a processing method that can be applied to a user equipment (such as a terminal device, specifically such as mobile phones, etc.), including the following steps:
S10: receiving downlink information;
S20: acquiring an actual transmission period of at least one synchronization signal block in a synchronization signal block burst set according to the downlink information.

In an embodiment, the S20 step includes at least one of the following:
acquiring the actual transmission periods of all synchronization signal blocks in the synchronization signal block burst set according to an energy indicator field and a period field;
acquiring the actual transmission period of the at least one synchronization signal block in the synchronization signal block burst set according to an energy indicator field, a period field and a synchronization signal block index field;
acquiring the actual transmission period of the at least one synchronization signal block in the synchronization signal block burst set according to an energy indicator field and a synchronization signal block index field.

In an embodiment, after step S20, the method further includes steps:
S30: in response to meeting a third preset condition, sending an uplink wake-up signal, where the uplink wake-up signal is used for determining a number of user equipments camping in at least one beam direction of the synchronization signal block burst set in a target cell.

In an embodiment, the meeting the third preset condition, includes at least one of the following:
reference signal receiving power of a synchronization signal/physical broadcast channel (SS/PBCH) block measured by the user equipment in a current serving cell is lower than an eighth target threshold;
a cumulative number of events where UE's preamble transmission attempts reach a maximum number of transmission attempts in the current serving cell is greater than a ninth target threshold.

A third aspect of the present application also provides a communication device, including:
a memory;
a processor;
where the memory stores a computer program, when the computer program is executed by the processor, any of the above processing methods is implemented.

The present application also provides a storage medium, where the storage medium stores a computer program, when the computer program is executed by a processor, any of the above processing methods is implemented.

The present application also provides a computer program product, including a computer program, when the computer program is executed by a processor, any of the above processing methods is implemented.

Through the processing method provided by the present application, a network device can send first downlink information to a user equipment and enter an energy saving state when a first preset condition is met. In an embodiment, the network device can suspend or increase a transmission period of at least one synchronization signal block in a synchronization signal block burst set, and notify the user equipment through the first downlink information to reduce transmission energy consumption of the network device and receiving energy consumption of the user equipment.

### BRIEF DESCRIPTION OF DRAWINGS

The drawings herein are incorporated into and form some specification, show embodiments that comply with the present application, and are used together with the specification to explain the rationale of the present application. In order to more clearly illustrate a technical scheme of the embodiments of the present application, the drawings required to be used in the description of the embodiments are briefly described below, and it is obvious that other drawings can be acquired from these drawings without creative effort on the some ordinary skilled persons in the art.

FIG. 1 is a hardware structure schematic diagram of a mobile terminal that realizes respective embodiments of the present application.

FIG. 2 is a communication network system architecture diagram provided by an embodiment of the present application.

FIG. 3 is an example diagram of an application scenario of a processing method shown by an embodiment.

FIG. 4 is a flow schematic diagram of a processing method shown by a first embodiment of the present application.

FIG. 5 is a flow schematic diagram of a processing method shown by a second embodiment of the present application.

FIG. 6 is an example diagram of period setting shown by an embodiment of the present application.

FIG. 7 is an example diagram of cancellation of sending shown by an embodiment of the present application.

FIG. 8 is an application example diagram of index setting shown by an embodiment of the present application.

FIG. 9 is an application example diagram of index setting shown by an embodiment of the present application.

FIG. 10 is a flow schematic diagram of a processing method shown by a third embodiment of the present application.

FIG. 11 is an example diagram of normal state transition shown by an embodiment of the present application.

FIG. 12 is a structural schematic diagram of a processing apparatus shown by a first embodiment of the present application.

FIG. 13 is a structural schematic diagram of a processing apparatus shown by a second embodiment of the present application.

FIG. 14 is a structure diagram of a communication device shown by an embodiment of the present application.

The realization of the purpose, functional characteristics and advantages of the present application will be further explained in conjunction with embodiments and with reference to the attached drawings. Clear embodiments of the present application have been shown by the drawings above and will be described in more detail later. These drawings and textual descriptions are not intended in any way to limit the scope of the ideas presented in the present application, but rather to illustrate the concepts of the present application for those skilled in the art by reference to specific embodiments.

### DETAILED DESCRIPTION OF EMBODIMENTS

Embodiments will be explained in detail here, examples of which are shown in the attached drawings. Where the description below relates to drawings, the same numbers in different drawings represent the same or similar elements unless otherwise indicated. The implementations described in the following embodiments do not represent all implementations consistent with the present application. Rather, they are merely examples of apparatus and methods that are consistent with aspects of the present application as detailed in the attached claims.

It should be noted that, in this context, the term “include”, “contain” or any other variation thereof is intended to cover non-exclusive inclusion so that a process, method, item, or apparatus including a set of elements includes not only those elements but also other elements not expressly listed. Or it may include elements inherent to the process, method, item, or apparatus. In the absence of further limitations, an element qualified by the sentence “including a . . . ” does not exclude the existence of another identical element in the process, method, item, or apparatus that includes the element, and in addition, components, features and elements with the same name in different embodiments of the present application may have the same meaning or may have different meanings. Its specific meaning shall be determined by its interpretation in the specific embodiment or by further combining the context in the specific embodiment.

It should be understood that although the terms first, second, third, etc. may be used to describe various types of information herein, such information should not be limited to these terms. These terms are used only to distinguish the same type of information from one another. For example, without leaving the scope of this article, first information can also be called second information, and similarly, the second information can also be called the first information. Depending on the context, the word “if” used here can be interpreted as “at the time of . . . ” or “when . . . ” or “in response to determining”. Furthermore, as used in this article, the singular forms “one”, “a”, and “the” are intended to include the plural form as well, unless the context indicates otherwise. It should be further understood that the terms “include”, “contain” indicate the presence of said features, steps, operations, elements, components, items, types, and/or groups, but do not exclude the presence, appearance, or addition of one or more other features, steps, operations, elements, components, items, types, and/or groups. The terms “or”, “and/or”, “including at least one of the following”, as used in the present application, may be construed as inclusive or to imply any one or any combination. For example, “including at least one of the following: A, B, C” means “any of the following: A; B; C; A and B; A and C; B and C; A and B and C”, as in “A, B or C” or “A, B and/or C” means “any of the following: A; B; C; A and B; A and C; B and C; A and B and C”. An exception to this definition occurs only when combinations of elements, functions, steps, or operations are inherently mutually exclusive in some way.

It should be understood that although the steps in the flow diagram in the embodiments of the present application are shown sequentially as indicated by the arrows, they are not necessarily performed sequentially in the order indicated by the arrows. Unless explicitly stated in this article, there is no strict order in which these steps can be performed, and they can be performed in other order. Moreover, at least part of the steps in the drawings may include multiple sub-steps or stages, which are not necessarily completed at the same time, but can be executed at different times, and their execution order is not necessarily sequential, but can be executed in turn or alternately with other steps or at least some the sub-steps or stages of other steps.

Depending on the context, the words “if” and “as if” used here can be interpreted as “at the time of . . . ” or “when . . . ” or “in response to determining” or “in response to detecting”. Similarly, depending on the context, the phrase “if determining” or “if detecting (stated condition or event)” can be interpreted as “when determining” or “in response to determining” or “when detecting (stated condition or event)” or “in response to detecting (stated condition or event)”.

It should be noted that, in this paper, the use of such as S10, S20 and other step code, its purpose is to more clearly and briefly express the corresponding content, does not constitute a substantial restriction on the order, those skilled in the art in the specific implementation, may first perform S20 and then S10, but these should be within the scope of protection of the present application.

It should be understood that the specific embodiments described herein are intended only to interpret the present application and are not intended to limit it.

In subsequent descriptions, suffixes such as “module”, “component” or “unit” used to represent elements are used only to facilitate the description of the present application and have no specific meaning in themselves. Therefore, the terms “module”, “component” or “unit” can be used in combination.

In the present application, a communication device can be a user equipment or a network device (such as a base station), which needs to be determined according to the context. In addition, the user equipment can be implemented in various forms. For example, the user equipment described in the present application may include such device as a mobile phone, tablet, laptop, palmtop, personal digital assistant (PDA), portable media player (PMP), navigation apparatus, wearable device, smart bracelet, pedometer and other mobile terminals, as well as a fixed terminal such as a digital television (TV), desktop computer.

A mobile terminal will be illustrated as an example of a user equipment in the following description, and it will be understood by those skilled in the art that in addition to elements specifically intended for the purpose of mobility, the construction according to the implementations of the present application can also be applied to fixed types of terminals.

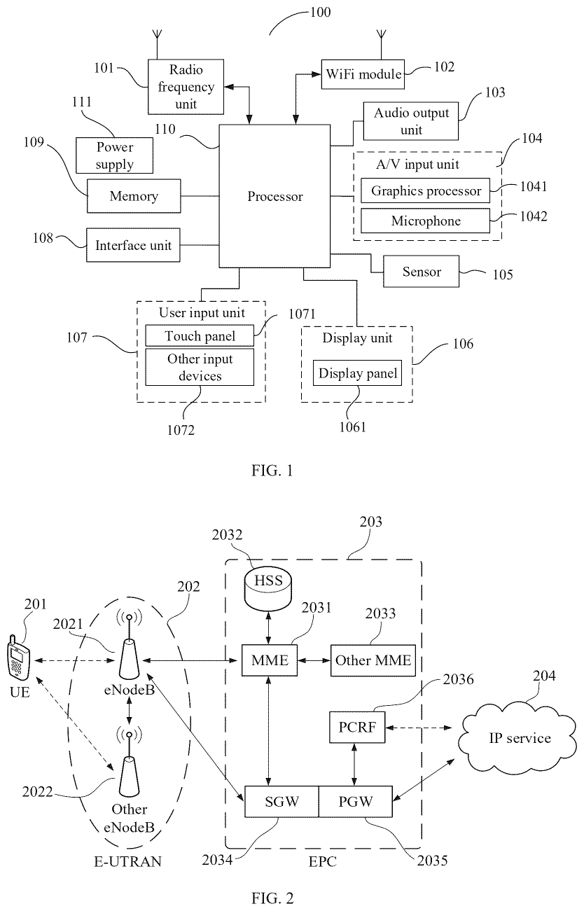

Please refer to FIG. 1, which is a hardware structure schematic diagram of a mobile terminal that realizes respective embodiments of the present application. The mobile terminal 100 may include: an RF (Radio Frequency, radio frequency) unit 101, a WiFi (Wireless Fidelity) module 102, an audio output unit 103, an A/V (Audio/Video) input unit 104, a sensor 105, a display unit 106, a user input unit 107, an interface unit 108, a memory 109, a processor 110, and a power supply 111 and other components. It may be understood by those skilled in the art that the structure of the mobile terminal shown in FIG. 1 does not constitute a limitation of the mobile terminal, the mobile terminal may include more or fewer components, or a combination of some components, or a different arrangement of components than shown in the figure.

Each component of the mobile terminal will be introduced in detail in conjunction with FIG. 1 in the following.

The RF unit 101 can be used to receive and send information or receive and send signals during a call. Specifically, after receiving downlink information from a base station, the RF unit 101 may pass the downlink information to the processor 110 for processing, and in addition, sending the uplink data to the base station. Typically, the RF unit 101 includes, but is not limited to, an antenna, at least one amplifier, a transceiver, a coupler, a low noise amplifier, a diplexer, and the like. In addition, the RF unit 101 can communicate with network and other devices via wireless communication. The above wireless communication can use any communication standard or protocol, including but not limited to GSM (Global System of Mobile communication), GPRS (General Packet Radio Service), CDMA2000 (Code Division Multiple Access 2000), WCDMA (Wideband Code Division Multiple Access), TD-SCDMA (Time Division-Synchronous Code Division Multiple Access), FDD-LTE (Frequency Division Duplexing-Long Term Evolution), TDD-LTE (Time Division Duplexing-Long Term Evolution) and 5G, and the like.

WiFi is a short-range wireless transmission technology. The mobile terminal can help a user receive and send emails, browse a web and access streaming media through the WiFi module 102, which provides the user with wireless broadband Internet access. Although the WiFi module 102 is shown in FIG. 1, it is understood that it is not a necessary component of the mobile terminal and can be omitted as required without changing the nature of the invention.

The audio output unit 103 can convert audio data received by the RF unit 101 or the WiFi module 102 or stored in the memory 109 into an audio signal and output it as sound when the mobile terminal 100 is in a call signal receiving mode, a call mode, a recording mode, a speech recognition mode, a broadcast receiving mode, and the like. Furthermore, the audio output unit 103 can also provide an audio output related to a specific function performed by the mobile terminal 100 (for example, call signal receiving sound, message receiving sound, etc.). The audio output unit 103 may include a speaker, a buzzer, and the like.

A/V input unit 104 is used to receive audio or video signals. The A/V input unit 104 may include a graphics processing unit (GPU) 1041, and a microphone 1042, the graphics processing unit processes image data of static pictures or videos acquired by an image capture apparatus (such as a camera) in a video capture mode or an image capture mode. A processed image frame can be displayed on the display unit 106. An image frame processed by the graphics processing unit 1041 can be stored in the memory 109 (or other storage medium) or be sent via the RF unit 101 or the WiFi module 102. The microphone 1042 can receive sound (audio data) in a phone call mode, a recording mode, a speech recognition mode, and other operating modes, and can process such sound as audio data. The processed audio (voice) data can be converted in the case of a telephone call mode into a format output that can be sent via RF unit 101 to a mobile communication base station. The microphone 1042 can implement various types of noise elimination (or suppression) algorithms to eliminate (or suppress) noise or interference generated during the process of receiving and sending audio signals.

The mobile terminal 100 also includes at least one sensor 105, such as a light sensor, a motion sensor, and other sensors. In an embodiment, the light sensor includes an ambient light sensor and a proximity sensor. In an embodiment, the ambient light sensor can adjust brightness of a display panel 1061 according to light and shade of the ambient light. The proximity sensor can turn off the display panel 1061 and/or backlight when the mobile terminal 100 is moved to an ear. As a kind of motion sensor, an accelerometer sensor can detect size of acceleration in all directions (generally three axes), and the size and direction of gravity can be detected at rest. It can be used to applications identifying mobile phone attitude (such as horizontal and vertical screen switching, related games, magnetometer attitude calibration), vibration recognition related functions (such as pedometer, tapping), etc. As for a fingerprint sensor, a pressure sensor, an iris sensor, a molecular sensor, a gyroscope, a barometer, a hygrometer, a thermometer, an infrared sensor and other sensors that can be configured by the phone, it will not be repeated here.

The display unit 106 is used to display information input by the user or providing to the user. The display unit 106 can include the display panel 1061, which can be configured in the form of liquid crystal display (LCD), organic light-emitting diode (OLED), etc.

The user input unit 107 can be used to receive input numeric or character information and to generate a key signal input related to user setting and functional control of the mobile terminal. In an embodiment, the user input unit 107 may include a touch panel 1071 and other input devices 1072. The touch panel 1071, also known as a touch screen, can collect a user's touch operation on or near it (such as a user's operation with a finger, stylus, or any suitable object or attachment on or near the touch panel 1071) and drive a corresponding connection apparatus according to a preconfigured program. The touch panel 1071 can include two parts: a touch detection apparatus and a touch controller. In an embodiment, the touch detection apparatus detects a user's touch orientation, detects a signal brought by the touch operation, and transmits the signal to the touch controller. The touch controller receives touch information from the touch detection apparatus, converts it into a contact coordinate, and then sends it to the processor 110, and can receive and execute a command from the processor 110. In addition, the touch panel 1071 can be implemented in various types of resistive, capacitive, infrared and surface acoustic wave. In addition to the touch panel 1071, the user input unit 107 may also include other input devices 1072. In an embodiment, other input devices 1072 may include, but are not limited to, one or more of a physical keyboard, a function keys (such as a volume control key, a switch key, etc.), trackball, mouse, joystick, etc., which are not limited here.

In an embodiment, the touch panel 1071 can cover the display panel 1061, and when the touch panel 1071 detects a touch operation on or near it, it transmits the touch operation to the processor 110 to determine the type of touch event. Then the processor 110 provides a corresponding visual output on the display panel 1061 according to the type of the touch event. Although in FIG. 1, the touch panel 1071 and the display panel 1061 are two independent components to realize the input and output functions of the mobile terminal, in some embodiments, the touch panel 1071 and the display panel 1061 can be integrated to realize the input and output functions of the mobile terminal, which are not limited here.

The interface unit 108 is used as an interface through which at least one external apparatus can be connected to the mobile terminal 100. For example, the external apparatus can include a wired or wireless headset port, an external power (or battery charger) port, a wired or wireless data port, a memory card port, a port for connecting an apparatus with an identification module, an audio input/output (I/O) port, a video I/O port, a headset port, and so on. The interface unit 108 may be used to receive input from the external apparatus (for example, data information, electricity, etc.) and transmit a received input to one or more elements within the mobile terminal 100 or may be used to transmit data between the mobile terminal 100 and the external apparatus.

The memory 109 can be used to store a software program as well as various data. The memory 109 may mainly include a program storage area and a data storage area. In an embodiment, the program storage area may store an operating system, an application program required for at least one function (such as a sound playback function, an image playback function, etc.), and the like. The data storage area can store data created according to the use of a phone (such as audio data, phone book, etc.). In addition, the memory 109 may include a high-speed random access memory, as well as non-volatile memory, such as at least one disk storage device, flash memory device, or other volatile solid-state storage device.

The processor 110 is a control center of the mobile terminal, connecting various parts of the entire mobile terminal using various interfaces and lines, executing various functions of the mobile terminal and processing data by running or executing software programs and/or modules stored in the memory 109, and calling the data stored in the memory 109, so as to carry out overall monitoring of the mobile terminal. The processor 110 may include one or more processing units. Preferably, the processor 110 can integrate an application processor and a modem processor. In an embodiment, the application processor mainly processes the operating system, a user interface and the application program, and the like. The modem processor mainly processes wireless communications. It can be understood that the above-mentioned modem processor can also not be integrated into the processor 110.

The mobile terminal 100 can also include the power supply 111 (such as a battery) that supplies power to various components. Preferably, the power supply 111 can be logically connected to the processor 110 through a power management system, so that the power management system can manage charging, discharging, and energy management functions.

Although not shown in FIG. 1, the mobile terminal 100 can also include a Bluetooth module, etc., which will not be detailed here.

In order to facilitate the understanding of the present application embodiment, a communication network system on which the mobile terminal of the present application is based is described below.

Please refer to FIG. 2, FIG. 2 is a communication network system architecture diagram provided by an embodiment of the present application. The communication network system is a NR system of the 5G. The NR system may include UE (user equipment) 201, an E-UTRAN (Evolved UMTS Terrestrial Radio Access Network) 202, an EPC (Evolved Packet Core) 203 and an operator's IP (Internet Protocol) service 204 that are communicatively connected in sequence.

In an embodiment, the UE 201 can be the above terminal 100, which will not be repeated here.

The E-UTRAN 202 includes an eNodeB 2021 and other eNodeBs 2022 and so on. In an embodiment, the eNodeB 2021 may be connected to other eNodeBs 2022 through a backhaul (for example, an X2 interface), the eNodeB 2021 is connected to the EPC 203, and the eNodeB 2021 may provide an access from the UE 201 to the EPC 203.

The EPC 203 may include an MME (Mobility Management Entity) 2031, an HSS (Home Subscriber Server) 2032, other MMEs 2033, an SGW (Serving Gate Way) 2034, a PGW (data packet network gateway) 2035 and a PCRF (Policy and Charging Rules Function) 2036, etc. In an embodiment, MME 2031 is a control node that processes signaling between the UE 201 and the EPC 203, and provides a bearer and a connection management. The HSS 2032 is used to provide some registers to manage functions such as home location register (not shown in the figure), and save some user specific information about service features, data rates, etc. All user data may be sent through the SGW 2034. The PGW 2035 may provide an IP address allocation of the UE 201 and other functions. The PCRF 2036 is a decision point for a policy and charging control policy of service data flow and an IP bearer resource, and selects and provides available a policy and charging control decision for a policy and charging execution functional unit (not shown in the figure).

The IP service 204 may include Internet, Intranet, IMS (IP multimedia subsystem) or other IP services.

Although an LTE system is introduced as an example above, those skilled in the art should be aware that the present application is not only applicable to the LTE system, but also can be applied to other wireless communication system, such as GSM, CDMA2000, WCDMA, TD-SCDMA, 5G, and new network systems (such as 6G) in future, and is not limited here.

Based on the mobile terminal hardware structure and the communication network system, embodiments of the present application are presented.

At present, there are more and more types of user equipment (UE) that can access the network, such as handheld user equipment, household appliances, wearable devices, smart home devices, etc., can access the network, and for example, mobile phones, tablets, refrigerators, televisions, air conditioners, smart watches, sports bracelets and other equipment.

The technical terms involved in the present application are described below.
Base station: a public mobile communication base station, which is a receiving device for a mobile device to access the Internet, that is, the network device involved in the present disclosure.
Cell: also called a cellular cell, refers to an area covered by a base station or part of the base station (a fan antenna) in a cellular mobile communication system, in which mobile user equipment can communicate with the base station.
SSB: synchronization signal and PBCH block (SSB), can include primary synchronization signals (PSS), and secondary synchronization signals (SSS), physical broadcast channel (PBCH).

A physical downlink share channel (PDSCH) is used for unicast or multicast data transmission, as well as transmission of paging messages and partial system messages.

A physical downlink control channel (PDCCH) is used to transmit downlink control information (DCI) of the network device to the user equipment. It includes scheduling assignment for PDSCH reception and scheduling authorization for PUSCH transmission, as well as power control, slot format indication, and resource preemption indication information.

A physical uplink control channel (PUCCH), mainly carries ACK (Acknowledgement)/NACK (Negative Acknowledgement), scheduling request (SR), channel state information (CSI) and other information.

A physical uplink shared channel (PUSCH) is used to carry related uplink service information or uplink signaling data from User Equipment. The term ‘shared’ refers to the same physical channel can be used by multiple UEs through time-division multiplexing (TDM), or the channel has a short duration.

Field: A field in downlink control information or radio resource control (RRC) parameter.

Transmission configuration indication state (TCI state) is used to provide quasi co-location (QCL) information for receiving downlink channel or reference signal, and/or provide uplink spatial filter information (spatial filter) for sending uplink channel or reference signal.

Transmission configuration indication field (TCI field) is used to indicate the transmission configuration indication state.

Downlink control information (DCI) belongs to information content carried by PDCCH, which can be sent by a network device to user equipment through a PDCCH channel, and can carry TCI fields.

In addition, the network device can also receive feedback information from the user equipment. In order to ensure effective and normal communication between the user equipment and the network device, the network device and the user equipment need to use the same configuration information, and the configuration information is mainly sent to the user equipment by the network device through the radio resource control (RRC) parameters or downlink control information (DCI).

In LTE scenarios, due to a small number of user equipments, the energy consumption of the network device is within a controllable range. However, with the popularity of 5G, the increase in a number of user equipments and network demand, the energy consumption of the network device is getting higher and higher, which is not conducive to the sustainable operation of the network.

In order to solve the above technical problem, a scheme provided by embodiments of the present application consider extending a period of a common signal sent by the network device. For a cell with less communication requirement, a transmission function of the network device can even be canceled or the transmission function of some beams can be terminated to reduce the signaling transmission load of the network device and solve the technical problem of high energy consumption of the network device.

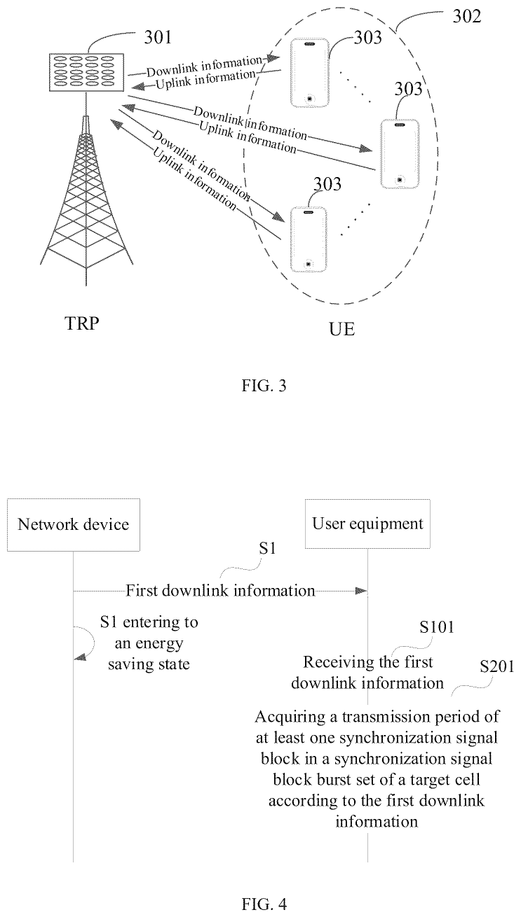

FIG. 3 is an example diagram of an application scenario of a processing method shown by an embodiment. As shown in FIG. 3, the network device TRP (Transmission/Reception Point) 301 can correspond to a target cell 302, and the target cell 302 can include a mobilizable user equipment 303. The network device 301 can send downlink information to the user equipment 303. The user equipment 303 can send uplink information to the network device 301.

FIG. 4 is a flow schematic diagram of a processing method shown by a first embodiment of the present application. The processing method provided by the present application can be applied to a network device (such as a base station), the network device can be accessed by user equipment.

As shown in FIG. 4, the processing method provided by the present application may include steps:

S1: in response to meeting a first preset condition, sending first downlink information and entering an energy saving state.

The energy saving state can refer to that the network device stops receiving and sending service data and can perform necessary transmission for a synchronization signal block. And a transmission period of the synchronization signal block is longer than a transmission period of the synchronization signal block in a normal state.

In an embodiment, the energy saving state can include at least one of deep sleep, light sleep, and micro sleep. The deep sleep, light sleep, or micro sleep can be one of sleep modes of the device. In one or more modes of deep sleep, light sleep and micro sleep, the device can enter a low-power state, that is, an energy saving state.

In an embodiment, the sequence of the step for sending the first downlink information in step S1 can be that the first downlink information is sent before or after entering the energy saving state. The sequence of steps shown in FIG. 3 is only illustrative and does not constitute a specific limitation on the sequence of steps that sending the first downlink information and entering the energy saving state.

In this embodiment, the network device can send the first downlink information and enter the energy saving state in a case that the first preset condition is met. The network device entering the energy saving state can perform necessary transmission for the synchronization signal block and/or receive the uplink wake-up signal at a specified time to reduce the energy consumption of the network device. By sending the first downlink information to the user equipment, the network device indicates that the user equipment enters the energy saving state by the first downlink information, so as to achieve communication synchronization between the user equipment and the network device, improve energy saving efficiency of the device, and avoid invalid information transmission from the user equipment to the network device.

In this embodiment, the network device can enter the energy saving state in response to meeting the first preset condition. Additionally, the network device can also return to the normal state when a second preset condition is met. That is, the network device can quickly switch between the energy saving state and a normal state through the first preset condition and the second preset condition.

In an embodiment, the first preset condition may include at least one of the followings.

A first type: numbers of user equipments (UEs) camping in all beam directions of the Synchronization Signal Block (SSB) burst set in the target cell are all less than the first target threshold.

In an embodiment, the numbers of user equipments (UEs) camping in all beam directions of the synchronization signal block burst set in the target cell are all less than the first target threshold, which can include that the numbers of the user equipments interacting with the network device for data on all beams set to 1 in the SSB-PositionsInBurst parameter, are all less than the first target threshold. A value of the first target threshold can be set according to actual usage requirements. For example, the value of the first target threshold can be associated with a working period of current user equipment. For example, whether the user equipment works during the daytime or at night, if it is daytime, the user equipment has high usage requirements, the first target threshold may be set to be large, and if it is night, the user equipment has low usage requirements, the first target threshold may be set to be small. In an embodiment, the first target threshold can be preconfigured during network deployment, or can be selected by the network device within an optional value range according to factors such as a device type.

In this embodiment, by acquiring a number of resident user equipments on all beams, transmission periods of all synchronization signal blocks in the synchronization signal block burst set of the target cell are increased, so as to reduce the energy consumption of the network device in sending the synchronization signal blocks and realize the purpose of saving energy of the network device.

A second type: numbers of data packets buffered for transmission and/or reception, in all beam directions of the synchronization signal block burst set in the target cell, are all less than a second target threshold, and/or, numbers of data transmission are all less than a third target threshold.

The numbers of data packets buffered for transmission and/or reception, in all beam directions of the synchronization signal block burst set in the target cell, are all less than the second target threshold, and/or, the numbers of data transmission are all less than the third target threshold. This can include that, in all beams set to 1 in the SSB-PositionsInBurst parameter, there is only small data packet transmission or an interval between two data transmission is relatively large. At this time, the target cell can inform the user equipment to transfer the data service to the cell corresponding to the neighboring base station in advance, and then the target cell can suspend or increase the transmission period of some synchronization signal blocks.

In this embodiment, the target cell can suspend or increase the transmission period of some synchronization signal blocks to reduce the energy consumption of the base station corresponding to the target cell when sending synchronization signal blocks, thereby achieving the purpose of energy saving of the network device.

A third type: a number of UEs camping in at least one beam direction of the synchronization signal block burst set in the target cell is less than a fourth target threshold.

The number of UEs camping in at least one beam direction of the synchronization signal block burst set in the target cell is less than the fourth target threshold, which mainly refers to that number of the user equipment performing data interaction with the network device on at least one beam set to 1 in the SSB-PositionsInBurst parameter is less than the fourth target threshold. The fourth target threshold can be associated with the working period of the current user equipment, for example, whether the user equipment works during the daytime or at night. The fourth target threshold can be preconfigured during network deployment, or can be selected by the network device within the optional value range according to factors such as a device type.

In this embodiment, by acquiring a number of resident user equipments on at least one beam, a transmission period of the synchronization signal blocks in a certain beam direction of the target cell can be increased, so as to reduce the energy consumption of the network device sending the synchronization signal blocks and realize the purpose of saving energy of the network device.

A fourth type: a number of data packets buffered for transmission and/or reception in at least one beam direction of the synchronization signal block burst set in the target cell is less than a fifth target threshold and/or a number of data transmission is less than a sixth target threshold.

In this embodiment, the number of the data packets buffered for transmission and/or reception in at least one beam direction of the synchronization signal block burst set in the target cell can be compared with the fifth target threshold and/or the number of data transmission can be compared with the sixth target threshold, respectively, so as to acquire a transmitted data packet size and/or number of transmission in at least one beam direction set to 1 in SSB-PositionsInBurst parameter, and then effectively adjust the number of user equipments in a certain beam direction. Finally, the network device turns off beam transmissions in some beam directions or increases a transmission period of beams in some beam directions in the target cell to achieve the purpose of network energy saving.

In an embodiment, multiple target thresholds are involved in this embodiment, for example, the first target threshold, the second target threshold, etc., can be set according to usage requirements. The relevant descriptions of “first” and “second” do not mean that each target has a sequence, nor does it mean that it has the meaning of numerical size.

In an embodiment, the target cell may be a coverage area of the network device, the network device communicates with the user equipment in the target cell.

At least one beam direction of the synchronization signal block (SSB) burst set can refer to transmission and reception directions of one or more synchronization signal blocks in the synchronization signal blocks burst set for which the value in the SSB-PositionsInBurst parameter is set to 1. In the present disclosure, by judging whether at least one beam direction of the synchronization signal blocks for which the value in the SSB-PositionsInBurst parameter is set to 1 meets the first preset condition, a period of some beams in the synchronization signal block burst set can be increased or the transmission of the some beams in the synchronization signal block burst set can be suspended, so as to realize the energy saving of the network device.

All beam directions in the synchronization signal block burst set can refer to transmission and reception directions of all synchronization signal blocks in the synchronization signal blocks for which the value in the SSB-PositionsInBurst parameter is set to 1. In this disclosure, by judging whether all the beam directions in the synchronization signal blocks for which the value in the SSB-PositionsInBurst parameter is set to 1 meet the first preset condition, the period of all beams in the synchronization signal block burst set can be increased simultaneously or the transmission of all the beams in the synchronization signal block burst set can be suspended, so as to realize energy saving of the network device.

In an embodiment, the energy saving state can include at least one of the followings.

A first type of the energy saving state: a transmission period of at least one synchronization signal block in the synchronization signal block burst set of the target cell is increased to a target period, and a transmission period of at least one synchronization signal block in the synchronization signal block burst set of the target cell is unchanged.

By extending the transmission period of synchronization signal blocks, the network device can reduce the frequency of sending synchronization signal blocks, increase sleep time of the network device, and thus reduce the energy consumption of the network device.

In this embodiment, by extending the transmission period of at least one synchronization signal block in the synchronization signal block burst set of the target cell to the target period, and maintaining the transmission period of at least one synchronization signal block unchanged, it is possible to prioritize the increase of the transmission period of the synchronization signal blocks in the idle state, when some synchronization signal blocks are in a busy state and some synchronization signal blocks are in an idle state. This maximizes the energy saving of the network device without affecting communication of the synchronization signal blocks in the busy state.

A second type of energy saving state: at least one synchronization signal block in the synchronization signal block burst set of the target cell is suspended and a transmission period of at least one synchronization signal block in the synchronization signal block burst set of the target cell is unchanged.

At least one synchronization signal block being suspended can refer to that a synchronization signal block in one or more beam directions in the synchronization signal block burst set is suspended. By reducing a number of synchronization signal blocks sent at the same time in a period time, the network device can reduce its energy consumption, thus achieve the purpose of energy saving.

In this embodiment, by suspending the transmission of at least one synchronization signal block in the burst set of the target cell and keeping the transmission period of at least one synchronization signal block in the synchronization signal block burst set of the target cell unchanged, it is possible to reduce the number of synchronization signal blocks which are in the idle state during a certain time when some synchronization signal blocks are in the busy state and some synchronization signal blocks are in the idle state. This achieves the energy saving of the network device.

A third type of energy saving state: all synchronization signal blocks in the synchronization signal block burst set of the target cell are suspended.

All synchronization signal blocks being suspended can refer to that all synchronization signal blocks set to 1 in the SSB-PositionsInBurst parameter are suspended to minimize the energy consumption of the network device.

In this embodiment, by suspending the transmission of all the synchronization signal blocks in the synchronization signal block burst set of the target cell, the base station corresponding to the target cell can be completely shut down or deactivated, so as to realize the energy saving of the network device.

A fourth type of energy saving state: transmission periods of all synchronization signal blocks in the synchronization signal block burst set of the target cell are increased to the target period.

Increasing the periods of all synchronization signal blocks can refer to simultaneously increasing the transmission periods of all synchronization signal blocks set to 1 in the SSB-PositionsInBurst parameter. Increasing a period of a synchronization signal block can reduce the number of sending the synchronization signal block by the network device, thereby effectively reducing the energy consumption of the network device.

In this embodiment, by extending the transmission periods of all synchronization signal blocks in the synchronization signal block burst set of the target cell to the target period, the number of synchronization signal block transmission by the network device can be reduced, and the sleep time of the network device can be increased, so as to achieve the goal of reducing the energy consumption of the network device.

In an embodiment, the first downlink information may indicate that the user equipment has entered the energy saving state, and a specific implementation method of the network device entering the energy saving state. In an embodiment, the network device can use the first downlink information to inform the user equipment whether the synchronization signal block transmission period is extended or whether the synchronization signal block transmission is suspended, and a specific index of the synchronization signal block whose period is extended or which is suspended, so as to realize the matching of the energy saving state operation of the network device and the user equipment.

Referring to FIG. 4, the network device can send the first downlink information to the user equipment in the target cell.

In an embodiment, the first downlink information can include downlink control information (DCI).

In an embodiment, the first downlink information may include at least one of the followings:
an energy indicator field for indicating an energy consumption state of the target cell;
a period field for indicating a transmission period of at least one synchronization signal block of the target cell;
a synchronization signal block index field for indicating a synchronization signal block index of the target cell.

In this embodiment, by sending the first downlink information to the user equipment in the target cell, the network device can enable the user equipment to transfer a service transmission in all or at least one synchronization signal block direction in advance to the cell corresponding to the neighboring base station or to other synchronization signal block directions, so as to better match the processing of the current energy-saving state of the target cell, and better achieve the energy saving of the network device.

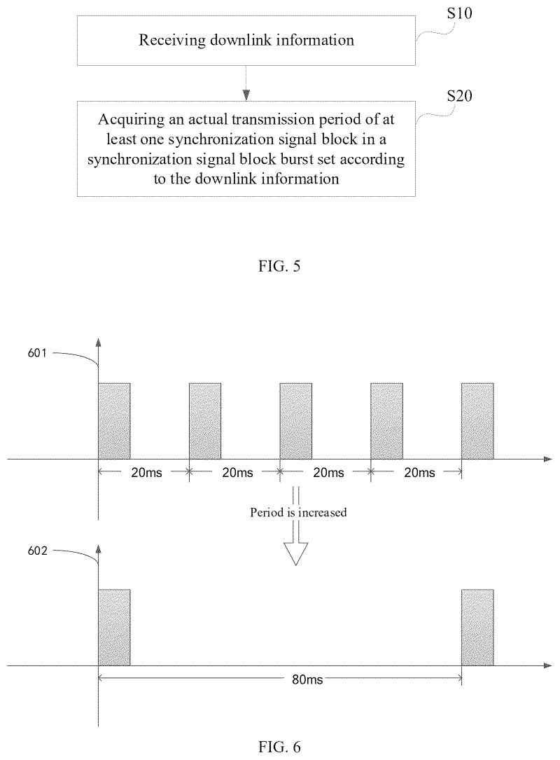

As shown in FIG. 5, it is a flow schematic diagram of a processing method shown by a second embodiment of the present application, which can be applied to user equipment. The method may include:
step S10: receiving downlink information;
step S20: acquiring an actual transmission period of at least one synchronization signal block in a synchronization signal block burst set according to the downlink information.

In an embodiment, the downlink information in step S10 in this embodiment may include first downlink information.

Referring to FIG. 4, after the network device sends the first downlink information, the user equipment performs step S10, which can specifically include step S101: receiving the first downlink information, and performing step S20 which can specifically include step S201: acquiring the transmission period of the at least one synchronization signal block in the synchronization signal block burst set of a target cell according to the first downlink information.

In an embodiment, the downlink information in step S10 can also include second downlink information.

In an embodiment, the second downlink information may include at least one of the following:
an energy indicator field for indicating an energy consumption state of the target cell;
a period field for indicating a transmission period of at least one synchronization signal block of the target cell;
a synchronization signal block index field for indicating a synchronization signal block index of the target cell.

In an embodiment, the second downlink information can also be legacy downlink control information that does not contain any of the energy indicator field, period field, or synchronization signal block index field.

In an embodiment, the user equipment can quickly acquire the actual transmission period of each synchronization signal block through the first or second downlink information, so that the user equipment can quickly match the specific processing of the energy saving state of the network device, and better realize the energy saving purpose of the network device.

In an embodiment, according to the first downlink information, the user equipment can acquire the index of synchronization signal block within the synchronization signal block burst set, whose period needs to be adjusted, and the adjustment direction of the synchronization signal block period. For example, according to the first downlink information, the user equipment can determine the adjustment direction, such as increasing the synchronization signal block period or directly suspending the synchronization signal block transmission.

In an embodiment, the user equipment can also restore the transmission period of at least one synchronization signal block within the synchronization signal block burst set according to the second downlink information. This mechanism helps alleviate scenarios in which the user equipment has poor transmission quality on some beams or encounters service interruptions in some cells.

In this embodiment, after the network device sends the downlink information, the user equipment can receive the downlink information sent by the network device. The downlink information can control the actual transmission period of at least one synchronization signal block in the synchronization signal block burst set. By extending the transmission period of the synchronization signal block or suspending the transmission of the synchronization signal block, the network device reduces the number of synchronization signal block transmission during a duration, thereby achieving a reduction in energy consumption of the network device.

In an embodiment, S20 step: acquiring an actual transmission period of at least one synchronization signal block in a synchronization signal block burst set according to the downlink information, which may include at least one of the following when performed in detail:
acquiring the actual transmission periods of all synchronization signal blocks in the synchronization signal block burst set according to an energy indicator field and a period field;
acquiring the actual transmission period of the at least one synchronization signal block in the synchronization signal block burst set according to the energy indicator field, the period field and a synchronization signal block index field;
acquiring the actual transmission period of the at least one synchronization signal block in the synchronization signal block burst set according to the energy indicator field and the synchronization signal block index field.

In an embodiment, acquiring the actual transmission periods of all synchronization signal blocks in the synchronization signal block burst set according to the energy indicator field and the period field can include: according to the energy indicator field in the downlink control information (DCI), acquiring whether the network device is currently in the energy saving state or normal state, then according to the period field, acquiring the specific transmission period when the network device is in the energy saving state or normal state. The adjustment of the transmission period in this scheme can be applied to all synchronization signal blocks set to 1 in the SSB-PositionsInBurst parameter.

In an embodiment, acquiring the actual transmission period of the at least one synchronization signal block in the synchronization signal block burst set according to the energy indicator field, the period field and the synchronization signal block index field can include: when there may be some beams on which no or only a few terminals perform data transmission and these beams are among all beams set to 1 in the synchronization signal block burst set, increasing transmission periods of these relatively idle beams to minimize the energy consumption of the network device.

In an embodiment, acquiring the actual transmission period of the at least one synchronization signal block in the synchronization signal block burst set according to the energy indicator field and the synchronization signal block index field can include: suspending the transmission period of some relatively idle beams among all beams set to 1 in the synchronization signal block burst set to achieve the purpose of energy saving of the network device. Compared with extending the SSB transmission period of the relative idle beams, this scheme can better reduce the energy consumption of the network device and reduce a number of bits of the downlink control information sent by the network device.

In this embodiment, the actual transmission periods of all synchronization signal blocks in the synchronization signal block burst set can be acquired according to the energy indicator field and the period field in the downlink information.

In an embodiment, downlink information can include the first downlink information or the second downlink information.

In an embodiment, the first downlink information may include at least one of the following:
the energy indicator field for indicating the energy consumption state of the target cell;
the period field for indicating the transmission period of at least one synchronization signal block of the target cell;
the synchronization signal block index field for indicating the synchronization signal block index of the target cell.

In this embodiment, take downlink information as the first downlink information to explain how to use the first downlink information, which include at least one of the energy indicator field, period field, and synchronization signal block index field, to constrain the transmission period of at least one synchronization signal block within the synchronization signal block burst set, so as to realize matching processing of transmission and reception between the network device and the user equipment in the energy saving state and better achieve energy saving of the network device.

In an embodiment, the energy indicator field in the first downlink information can occupy one bit. In an embodiment, if the energy indicator field is set to “0”, it is indicate that the current target cell is in a normal state, and if the energy indicator field is set to “1”, it is indicate that the current target cell is in an energy saving state.

In an embodiment, the period field in the first downlink information can occupy three bits. Different bit value combinations can refer to different synchronization signal block transmission periods. For example, 000 can refer to a period of 5 ms, 001 can refer to a period of 10 ms, 010 can refer to a period of 20 ms, 011 can refer to a period of 40 ms, 100 can refer to a period of 80 ms, and 101 can refer to a period of 160 ms.

In an embodiment, different bit value combinations can also refer to that the transmission period of the synchronization signal block in the energy saving state is a multiple of the transmission period of a synchronization signal block in the current high-level configuration. For example, 000 can refer to that the transmission period of the synchronization signal block in the energy saving state is 1 times the transmission period of the synchronization signal block in the current high-level configuration. 001 can refer to that the transmission period of the synchronization signal block in the energy saving state is 2 times the transmission period of the synchronization signal block in the current high-level configuration. 010 can refer to that the transmission period of the synchronization signal block in the energy saving state is 4 times the transmission period of the synchronization signal block in the current high-level configuration. 011 can refer to that the transmission period of the synchronization signal block in the energy saving state is 8 times the transmission period of the synchronization signal block in the current high-level configuration.

Certainly, the bit length of the above period and the specific period length corresponding to the bit value combinations can be set according to the usage requirements. The above is merely exemplary and should not constitute a specific limitation on the technical scheme of the present disclosure.

In an embodiment, the energy consumption state of the target cell can include an energy saving state and a normal state. In the energy saving state, the base station can effectively reduce the number of the synchronization signal block transmissions, hereby reducing energy consumption. In the normal state, the base station maintains normal number of the synchronization signal block transmissions and the service procedures, with network energy consumption remaining normal.

In an embodiment, in the technical scheme, a synchronization signal block burst set (SSB burst set) can include up to 64 candidate synchronization signal block (SSB). For example, if an SSB Burst set containing 8 candidate SSBs, the high-level parameter SSB-PositionsInBurst can contain 8 bits, with each bit can refer to a candidate SSB. Each candidate SSB can include SSB identification, which can be represented by a position number, such as SSB #1 for a first position parameter, SSB #2 for a second position parameter, and so on. For example, if SSB-PositionsInBurst is set to ‘01101010’, it represents that among the 8 candidate SSBs in a synchronization signal block burst set, only 4 synchronization signal blocks are actually transmitted, namely SSB #2, SSB #3, SSB #5 and SSB #7.

In an embodiment, all candidate synchronization signal blocks in a synchronization signal block burst set can be sent within 5 ms (millisecond).

In an embodiment, the transmission of all synchronization signal blocks in the synchronization signal block burst set can be suspended according to the energy indicator field.

In an embodiment, if a carrier frequency f meets: 3 GHz<f<=6 GHZ, an SSB Burst set contains 8 candidate SSBs, and the high-level parameter SSB-PositionsInBurst=‘01101010’, beam directions corresponding to only 4 SSBs of the 8 candidate SSBs are used for data transmission and reception. If the energy indicator field in the first downlink information received by the user equipment is 1, it represents the base station has entered the energy saving state and no longer performs any synchronization signal block transmission.

In an embodiment, the actual transmission periods of all synchronization signal blocks in the synchronization signal block burst set can be acquired according to the energy indicator field and the period field.

In an embodiment, when the carrier frequency f meet: 3 GHz<f<=6 GHz, an SSB Burst set contains 8 candidate SSBs. If the high-level parameter SSB-PositionsInBurst=‘01101010’, beam directions corresponding to only 4 SSBs of the 8 candidate SSBs are used for data transmission and reception. The four synchronization signal blocks are respectively SSB #2, SSB #3, SSB #5 and SSB #7 as shown in Table 1 below (positions marked with gray in the table):

TABLE 1

| | | | | | | | |
|---|---|---|---|---|---|---|---|
| SSB#1 | SSB#2 | SSB#3 | SSB#4 | SSB#5 | SSB#6 | SSB#7 | SSB#8 |

Assuming that a normal SSB transmission period is configured to 20 ms by a high-level parameter ssb-periodicityServingCell. If the energy indicator field in the downlink control information (DCI) is set to “1” and the period field is set to “100”, where a period field is “100” represents the SSB transmission period of 80 ms, then upon receiving the first downlink information containing the energy indicator field and the period field, the user equipment will know that the current base station has entered the energy saving state, and the transmission period of the synchronization signal blocks SSB #2, SSB #3, SSB #5 and SSB #7 will be increased from the original 20 ms to 80 ms. The network device can reduce the transmission energy consumption of the base station and realize network energy saving by increasing the transmission periods of all synchronization signal blocks set to 1 in the SSB-PositionsInBurst parameter.

For ease of understanding, FIG. 6 shows a schematic diagram of increasing a transmission period of a synchronization signal block. In the schematic diagram, a horizontal axis represents a time axis, and a vertical axis represents the number of resource blocks occupied by the synchronization signal block in the frequency domain. When the base station is in the normal state, 601 in the schematic diagram represents a transmission period interval of the synchronization signal block, and an interval size is 20 ms; when the base station is in the energy saving state, 602 in the schematic diagram represents a transmission period interval of the synchronization signal block, and the interval size increases from 20 ms to 80 ms. As shown in FIG. 6, in the normal state, the base station needs to send the synchronization signal block four times within 80 ms, while in the energy saving state, the base station only needs to send the synchronization signal block once within 80 ms. That is, the base station can reduce a number of synchronization signal blocks transmission per unit time by extending the transmission period of the synchronization signal blocks in the energy saving state, thereby reducing the energy consumption of the network device and achieving the purpose of network energy saving.

In an embodiment, the base station can also directly suspend a transmission of the synchronization signal block as shown in FIG. 7. When the base station is in the normal state, 701 in FIG. 7 represents that the transmission period of the synchronization signal block is 20 ms. When the first preset condition is met, 702 in FIG. 7 represents that the base station enters the energy saving state, and the synchronization signal block is directly suspended at this time. In other words, the base station directly suspends transmission of the synchronization signal block in the energy saving state as shown in 702 in FIG. 7 to reduce the energy consumption of the network device.

In an embodiment, the network device can also simultaneously increase transmission periods of all synchronization signal blocks in a synchronization signal block burst set or suspend all synchronization signal blocks transmissions in a synchronization signal block burst set. Additionally, the user equipment can be notified of network device's specific synchronization signal block transmission processing operations in the energy saving state through the energy indicator field and the period field in the first downlink information.

In an embodiment, the first downlink information can also include a synchronization signal block index field. And a number of first bits occupied by the synchronization signal block index field can be equal to a number of second bits set to 1 in the SSB-PositionsInBurst parameter.

In an embodiment, if a number of bits set to 1 in the SSB-PositionsInBurst parameter is 4, a number of bits occupied by a new synchronization signal block index field in the first downlink information is also 4.

In this embodiment, a number of the first bits occupied by the synchronization signal block index field is set equal to a number of the second bits set to 1 in the SSB-PositionsInBurst parameter. Compared to setting a number of the first bits occupied by the synchronization signal block index field to a number of candidate synchronization signal blocks, this approach can save the downlink control information bits. And it can also achieve the same purpose of notifying the user equipment about how the base station deals with the synchronization signal blocks in the energy saving state.

In an embodiment, the SSB-PositionsInBurst parameter refers to the high-level parameter SSB-PositionsInBurst, and only the beam transmission direction, corresponding to the synchronization signal block with the bit set to 1 in the SSB-PositionsInBurst, is used by the user equipment for data reception and transmission.

In an embodiment, the actual transmission period of the at least one synchronization signal block in the synchronization signal block burst set can be acquired according to the energy indicator field and the synchronization signal block index field.

For example, if the carrier frequency f meets: 3 GHz<f<=6 GHz, an SSB set contains 8 candidate SSB positions. If the high-level parameter SSB-PositionsInBurst=‘01101010’, a number of the second bit set to 1 in the SSB-PositionsInBurst parameter is 4. And Since a number of the first bits occupied by the synchronization signal block index field is equal to a number of the second bit set to 1 in the SSB-PositionsInBurst parameter, the synchronization signal block index field occupies 4 bits.

In an embodiment, each bit of the synchronization signal block index field can respectively refer to the transmission state of the signal blocks set to 1 in the SSB-PositionsInBurst parameter.

In an embodiment, if a target bit of the synchronization signal block index field is set to 1, it indicates that the corresponding synchronization signal block in the SSB-PositionsInBurst parameter is suspended.

In an embodiment, if the target bit of the synchronization signal block index field is set to 0, it indicates that the corresponding synchronization signal block in the SSB-PositionsInBurst parameter maintains normal transmission at the original period.

For ease of understanding, the SSB-PositionsInBurst set as ‘01101010’ is also take as an example, that is, only the beam directions corresponding to SSB #2, SSB #3, SSB #5 and SSB #7 in the 8 candidate synchronization signal blocks are used for data transmission by the user equipments and the network device. Because a number of the first bits occupied by the synchronization signal block index field is equal to a number of the second bit set to 1 in the SSB-PositionsInBurst parameter, a number of bits occupied by the synchronization signal index block is 4. The 1-st bit refers to SSB #2 in the synchronization signal block burst set, the 2-nd bit refers to SSB #3 in the synchronization signal block burst set, the 3-rd bit corresponds to SSB #5 in the synchronization signal block burst set, and the 4-th bit refers to SSB #7 in the synchronization signal block burst set. The bit value of the synchronization signal index block can be used to control the transmission of the corresponding synchronization signal block in the SSB-PositionsInBurst parameter. For example, if a bit is set to 1, the corresponding synchronization signal block is suspended. If a bit is set to 0, the corresponding synchronization signal block maintains its normal transmission period. For example, if a synchronization signal block index field “SS/PBCH index” is set to “0110”, it can be determined that in SSB #2, SSB #3, SSB #5, and SSB #7, the synchronization signal blocks corresponding to SSB #3 and SSB #5 are suspended, while the synchronization signal blocks corresponding to SSB #2 and SSB #5 maintains its normal transmission period.

In an embodiment, the actual transmission period of the at least one synchronization signal block in the synchronization signal block burst set can be acquired according to the energy indicator field, the period field, and the synchronization signal block index field.

In an embodiment, each bit of the synchronization signal block index field can respectively refer to the transmission state of the synchronization signal blocks set to 1 in the SSB-PositionsInBurst parameter.

In an embodiment, if a target bit of the synchronization signal block index field is set to 1, a transmission period of the corresponding synchronization signal block in the SSB-PositionsInBurst parameter is increased to a period value indicated by the period field.

In an embodiment, if the target bit of the synchronization signal block index field is set to 0, the corresponding synchronization signal block in the SSB-PositionsInBurst parameter maintains its original period for normal transmission.

For ease of understanding, assume that the carrier frequency f meets: 3 GHz<f<=6 GHz, and an SSB set contains 8 candidate SSB positions. If the SSB-PositionsInBurst field is set to 01101010′, it indicates that only the beam directions corresponding to SSB #2, SSB #3, SSB #5 and SSB #7 in the 8 candidate synchronization signal blocks are used for data transmission by the user equipments and the network device. Since a number of the first bits occupied by the synchronization signal block index field is equal to a number of the second bit set to 1 in the SSB-PositionsInBurst parameter, a number of bits occupied by the synchronization signal index block is 4. The 1-st bit refers to SSB #2 in the synchronization signal block burst set, the 2-nd bit refers to SSB #3 in the synchronization signal block burst set, the 3-rd bit refers to SSB #5 in the synchronization signal block burst set, and the 4-th bit refers to SSB #7 in the synchronization signal block burst set. The bit value of the synchronization signal index block can be used to control the transmission of corresponding synchronization signal block in the SSB-PositionsInBurst parameter. For example, if the bit value is set to 1, the transmission period of the corresponding synchronization signal block is increased to the period indicated by the period field in the downlink information. If the bit is set to 0, the corresponding synchronization signal block maintains its normal transmission period. For example, if the synchronization signal block index field “SS/PBCH index” is set to “0110” and the period indicator field is set to “100”, the transmission period of the corresponding SSB is 80 ms. And if the high-level parameter ssb-periodicityServingCell is set to ‘20 ms’, it can be determined that in SSB #2, SSB #3, SSB #5 and SSB #7, the synchronization signal block period corresponding to SSB #3 and SSB #5 increases to 80 ms, while the synchronization signal block corresponding to SSB #2 and SSB #5 maintains its normal transmission period.

In an embodiment, by limiting the number of SSBs transmitted each time, multiple candidate positions in the synchronization signal block burst set of a single transmission can be dispersed to multiple transmission periods, thereby extending the transmission periods of the synchronization signal blocks, reducing the energy of the synchronization signal blocks sent by the base station each time, and realizing the energy consumption of the network device. For example, a fixed number of SSBs that can be sent in each transmission period can be set to N1. According to the number set to 1 in the SSB-PositionsInBurst parameter, a number of actually transmitted SSBs is acquired as N2. Therefore, a number of SSBs that can be sent in each SSB period transmission position is set to a value less than or equal to the minimum values of N1 and N2.

If the SSB-PositionsInBurst is set to ‘01111110’, then the number N2 of actually transmitted SSBs in the 8 candidate SSBs can be 6. Assuming that the fixed number N1 of SSBs that can be sent in each transmission period is 4, the number N of SSBs that can be sent in each SSB period can be 4, where N=min (N1, N2). In this case, it means the candidate position in the SSB set for single transmission is 4. Among the 8 candidate SSBs, 6 actually transmitted SSBs can be fully sent through ceil (N2/N) periods. That is, 6 actually transmitted SSBs can be fully sent within the existing 2 SSB periods. In an embodiment, a number N of transmitted SSBs in the first SSB transmission period can be set to 4, and a number of remaining transmitted SSBs in the second SSB transmission period can be set to 2 which is equal to N1−N.

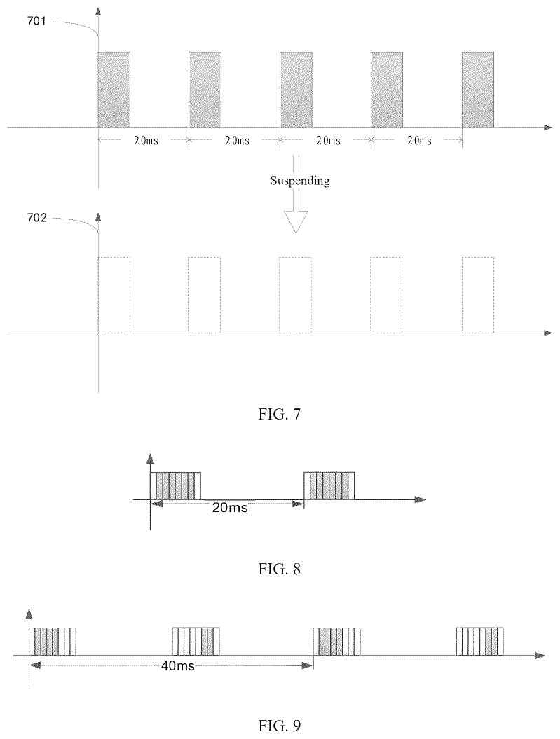

For ease of understanding, in the example diagram of index setting shown in FIG. 8, the SSB-PositionsInBurst can be set to ‘01111110’, and the ssb-periodicityServingCell can be set to 20 ms which indicates the transmission period of the SSB is 20 ms. For example, the number N2 of actually transmitted SSBs is set to 6. If the fixed number N1 of SSBs that can be sent in each transmission period, for example, is 4, the maximum number of SSBs that can be sent in each SSB period is N=min (N1, N2), and N can be 4. In an embodiment, the example diagram of index setting shown in FIG. 9, the first 4 synchronization blocks, such as SSB #2, SSB #3, SSB #4, SSB #5, can be transmitted for the first time and the remaining synchronization signal blocks, such as SSB #6 and SSB #7, can be transmitted for the second time. By limiting the number of transmitted SBBs each time, the transmission period of synchronization signal block in the SSB-PositionsInBurst parameter can be increased without changing the carrying bit of downlink control information, thus reducing the energy consumption of each transmission of synchronization signal blocks by the base station and realizing the energy saving of the network device.

In an embodiment, when increasing the transmission period of the synchronization signal block by limiting a number of SSBs in each transmission, the purpose of saving network energy consumption can still be achieved without increasing the carrying bit in the downlink control information.

In an embodiment, according to the scheme as described in the above embodiments, limiting a number of SSBs in each transmission may also be combined with at least one of the energy indicator field, period field, and/or synchronization signal block index field in the downlink information to further reduce network energy consumption.

According to the above embodiment, when the network device enters the energy saving state, the energy of the base station sending synchronization signal block, is reduced by: suspending transmission of all synchronization signal blocks in the synchronization signal block burst set, increasing the transmission periods of all synchronization signal blocks in the synchronization signal block burst set, increasing the transmission period of at least one synchronization signal block in the synchronization signal block burst set, suspending transmission of at least one synchronization signal block in the synchronization signal block burst set, or limiting the synchronization signal blocks in the synchronization signal block burst set in each transmission. The user equipment can receive the first downlink information sent by the network device before the network device enters the energy saving state, and acquires the specific synchronization signal block transmission handling methods by the base station in the energy saving state, thereby better matching the service transmission in the network's energy saving state. However, a base station can only handle a limited number of UEs or services. When the sudden traffic volume surges or a number of UEs within the base station's coverage area increases significantly, the base station serving these UEs cannot always be in an energy saving state. Therefore, the base station needs to be switched to the normal working state.

In an embodiment, after the base station enters the energy saving state, based on a third preset condition, the user equipment can send an uplink wake-up signal to wake up the base station.

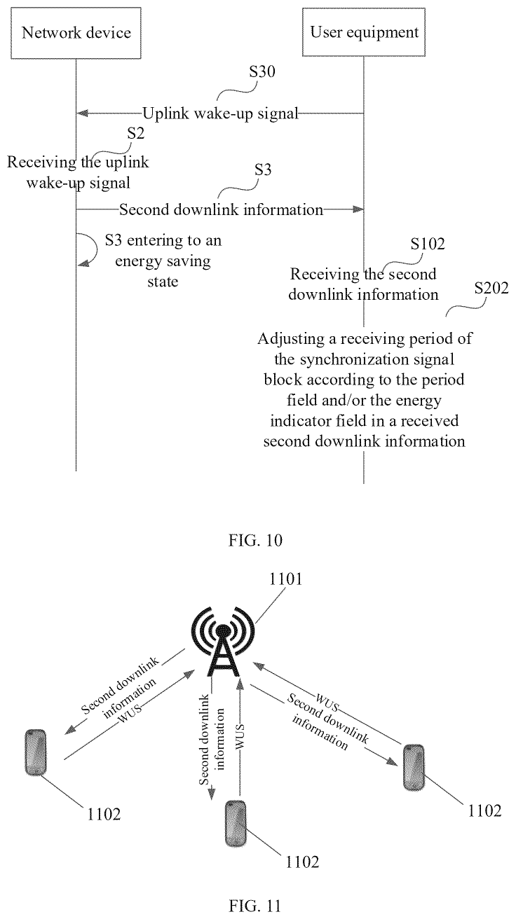

As shown in FIG. 10, it is a flow schematic diagram of a processing method shown by a third embodiment of the present application.

The user equipment may perform step S30, in response to meeting a third preset condition, sending an uplink wake-up signal, where the uplink wake-up signal is used for determining a number of UEs camping in at least one beam direction of the synchronization signal block burst set in the target cell.

In this embodiment, the user equipment initiates a switch to the network device by sending the uplink wake-up signal, to realize the energy consumption state switch according to the usage demand of the user equipment, and to realize the energy consumption state switch quickly and effectively.

In an embodiment, the meeting the third preset condition, includes at least one of the following:
reference signal receiving power of a SS/PBCH block measured by the user equipment in a current serving cell is lower than an eighth target threshold;
a cumulative number of events where the UE's preamble transmission attempts reach a maximum number of transmission attempts in the current serving cell is greater than a ninth target threshold.

In an embodiment, the current serving cell can be a cell that can also be covered by the base station in an energy saving state.

The reference signal receiving power of the SS/PBCH block of the user equipment in the current serving cell can represent the key parameters of wireless signal strength and the measurement requirements of the physical layer in LTE or 5G networks. If the received power is too low, it indicates that a current serving base station is far away from the user equipment, and a terminal data packet error rate will be relatively high, and the user equipment needs to switch to the closer serving base station.

An event where preamble transmission attempts reach a maximum number of transmission attempts can refer to that preamble transmission attempts is greater than the maximum number of transmission attempts configured by the high-level parameter. This scenario usually occurs when too many user equipments are connected to the current serving base station and the base station is overloaded. The user equipments need to initiate random access to other nearby serving base stations to ensure the normal transmission of service data.

In this embodiment, when the reference signal receiving power of the SS/PBCH block in the current serving cell is lower than the eighth target threshold, the user equipment may initiate the uplink wake-up signal to the network device. In an embodiment, when a cumulative number of events where UE's preamble transmission attempts reach a maximum number of transmission attempts in the current serving cell is greater than a ninth target threshold, the user equipment can also initiate the uplink wake-up signal to the network device. After receiving the uplink wake-up signal sent by the user equipment, the base station determines, based on the second preset condition, whether to switch from the energy saving state to the normal state, and then restores the normal service transmission function.

It should be noted that the technical scheme involves multiple thresholds, such as the first target threshold, the second target threshold, etc. Different thresholds are for the numerical judgment of different parameters, which can be determined according to the judgment requirements of each parameter. The threshold settings of each parameter can affect the results of different parameters and improve the accuracy of threshold judgment.

In some embodiments, referring to FIG. 10, after the user equipment performs step S30, the network device may perform step S2: receiving the uplink wake-up signal.

In an embodiment, the uplink wake-up signal includes at least one of the following:
a UE identification;
a specific synchronization signal block index;
a specific synchronization signal block period;
a preamble sequence;
a tracking reference signal sequence;
a demodulation reference signal (Demodulation Reference Signal, Demodulation Reference Signal)-like sequence carried on a PUSCH.

In an embodiment, the uplink wake-up signal can be a periodic signal, that is, transmission is performed at a fixed period position.

In an embodiment, the uplink wake-up signal can also be sent by each slot and each subframe.

In an embodiment, the UE identification can be a type identification of the user equipment or the user equipment ID (UE ID) of the user equipment.

In an embodiment, the base station may determine, through the uplink wake-up signal sent by the user equipment, a number of UEs camping in at least one beam direction of the synchronization signal block burst set in the target cell.

In this embodiment, by receiving the uplink wake-up signal sent by the user equipment, the network device can better know the usage demand of the user equipment in the cell served by the base station, and can better achieve the balance between energy saving and service transmission according to the demand of the user equipment in the cell served by the base station, so as to improve the accuracy and efficiency of energy consumption control of the network device.

Referring to FIG. 10, the network device can also perform step S3: in response to meeting a second preset condition, sending second downlink information and entering a normal state. The second downlink information can be sent by the network device to the user equipment.

In this embodiment, after switching to the energy saving state, the network device can enter the normal state if the second preset condition is met.

In an embodiment, FIG. 11 is an example diagram of the normal state transition, as shown in the FIG. 11, user equipment 1102 can send an uplink wake-up signal (WUS) to the network device 1101.

The network device 1101 can switch from the energy saving state to the normal state according to the second preset condition, and at the same time, send the second downlink information to the user equipment 1102.

In an embodiment, the meeting a second preset condition, includes at least one of the following:
a first type of meeting the second preset condition may include: numbers of UEs camping in all beam directions of the synchronization signal block burst set in the target cell are all greater than or equal to the first target threshold.

The network device can determine a number of UEs that will camp in a beam direction according to a number of UE ID in the uplink wake-up signal received on that beam. If the numbers of UE camping in all beam directions of the synchronization signal block burst set are all greater than or equal to the first target threshold, the network device can switch from the energy saving state to the normal state.

In an embodiment, the numbers of user equipments camping in all beam directions are all greater than or equal to the first target threshold, which may include a total number of user equipments acquired by adding together numbers of user equipments camping in each beam direction is greater than or equal to the first target threshold, or a maximum value of numbers of user equipments camping in each beam direction is greater than or equal to the first target threshold, or, numbers of user equipments camping in each beam direction are all greater than or equal to the first target threshold.

In this embodiment, the network device achieves the balance between network energy saving and service transmission service by determining that the numbers of UEs camping in all beam directions of the synchronization signal block burst set in the target cell are all greater than or equal to the first target threshold.

A second type of meeting the second preset condition may also include: numbers of data packets buffered for transmission and/or reception, in all beam directions of the synchronization signal block burst set in the target cell, are all greater than or equal to the second target threshold, and/or, numbers of data transmission are all greater than or equal to the third target threshold.

The number of data packets may include a number of data packets buffered for transmission by the network device and a number of data packets buffered for transmission by the user equipment. In an embodiment, the number of data packets buffered for transmission by the user equipment may be carried in the uplink wake-up signal to indicate the number of data packets buffered for transmission by the network device.

The number of data transmission can refer to the number of data packets reception and/or transmission per unit time. The unit time can be 1 time slot, 1 subframe, 1 wireless frame, or other units of count.

In this embodiment, the network device can perform threshold judgment according to quantities of data packets reception and/or transmission in all beam directions and/or the number of data transmission to realize the detection and judgment of data transmission requirements in all beam directions. Accurate device control for the network device can be achieved by using the data transmission requirements, which can also improve the control efficiency and accuracy.

A third type of meeting the second preset condition may include: a number of UEs camping in at least one beam direction of the synchronization signal block burst set in the target cell, is greater than or equal to the fourth target threshold.

The number of UEs camping in at least one beam direction of the synchronization signal block burst set may include the number of UE ID of the uplink wake-up signal sent in at least one beam direction.

In this embodiment, the network device performs threshold judgment for the number of UEs camping in some the beam directions, and controls the granularity of the base station sending the synchronization signal block within a beam range, which can better reduce the energy of the base station sending synchronization signal block and realize the energy saving of the network device.

A fourth type of meeting the second preset condition may include: a number of data packets buffered for transmission and/or reception, in at least one beam direction of the synchronization signal block burst set in the target cell, is greater than or equal to the fifth target threshold, and/or, the number of data transmission is greater than or equal to the sixth target threshold.

In an embodiment, all beam directions refer to beam directions corresponding to all synchronization signal blocks set to 1 in the SSB-PositionsInBurst parameter. The processing for synchronization signal blocks in all beam directions is processed by that one synchronization signal block burst set is taken as one unit.

In an embodiment, at least one beam direction refers to a beam direction corresponding to one or more synchronization signal blocks set to 1 in the SSB-PositionsInBurst parameter. The processing for synchronization signal blocks in at least one beam direction is processed by that one beam in one synchronization signal block burst set is taken as one unit.

In this embodiment, the network device detects the data transmission requirements of the network device in some beam directions by comparing the number of data packets buffered for transmission and/or reception, in at least one beam direction of the synchronization signal block burst set in the target cell, with the fifth target threshold, and/or, comparing the number of data transmission with the sixth target threshold. More accurate energy consumption state control can be achieved through the detection of data transmission requirement in some the beam directions. When there is a large data transmission requirement in some the beam directions, transmission can be initiated, and the accuracy of data transmission requirement setting can be improved.

In an embodiment, the entering the normal state, includes at least one of the following:
a transmission period of at least one synchronization signal block with bit set to 1 in the SSB-PositionsInBurst parameter of the target cell is consistent with a period configured by ssb-periodServingCell;
transmission periods of all the synchronization signal blocks with bit set to 1 in the SSB-PositionsInBurst parameter of the target cell is consistent with the period configured by the synchronization signal block period parameter of the serving cell.

In an embodiment, a synchronization signal block period of a serving cell of a high-level parameter (ssb-periodicityServingCell) is used to configure the transmission period of the synchronization signal block in the synchronization signal block burst set.

In this embodiment, the transmission period of at least one synchronization signal block of the target cell is consistent with a period configured by ssb-periodServingCell, and/or the transmission periods of all synchronization signal blocks with bit set to 1 in the burst set position parameter of the target cell is consistent with the period configured by the synchronization signal block period parameter of the serving cell. By adjusting the settings of the transmission period and/or the burst set position parameter, period adjustment of the network device is realized, and the efficiency and accuracy of the periodic adjustment of the network device are improved.

In an embodiment, the target cell includes at least one of the following:
in carrier aggregation, a secondary cell whose TA value resides within the same Time Advance Group (TAG) as those of a primary cell;
in the carrier aggregation, a secondary cell corresponding to a micro base station whose distance from a primary cell corresponding to a macro base station is less than a seventh target threshold;
a component carrier that does not carry downlink control information during cross-carrier scheduling in carrier aggregation;
a component carrier where the downlink control information resides during self-scheduling.

In an embodiment, the TA value (time advance) can ensure that multiple user equipment arrive at the base station at the same time.

In an embodiment, carrier aggregation (CA) refers to aggregating two or more component carriers (CC) together to support greater transmission bandwidth.

In an embodiment, one cell in communication is equivalent to one component carrier.

The target cell can be a secondary cell in carrier aggregation, whose TA value resides within the same time advance group as those of the primary cell. It can refer to that the TA value of the target cell's carrier in the carrier aggregation and the TA value of the primary cell's carrier belongs to the same time advance group.

In an embodiment, the base station can be divided into a macro base station and a micro base station according to their coverage/transmit power size.

The target cell can be the secondary cell corresponding to the micro base station whose distance from the primary cell corresponding to the macro base station in the carrier aggregation is less than the seventh target threshold.

The target cell can be the component carrier that does not carry downlink control information in carrier aggregation.

The target cell can be the component carrier where the downlink control information resides during self-scheduling.

In this embodiment, after the target cell is determined, whether the base station corresponding to the target cell is in the energy saving state can be judged according to the first preset condition. If the base station corresponding to the target cell is in the energy saving state, the service of the user equipment served by the target cell can be switched to the serving cell corresponding to other neighboring base stations to reduce the energy consumption of the serving base station of the target cell. In an embodiment, the secondary cell in carrier aggregation, whose TA value resides within the same time advance group as those of the primary cell can be configured as the target cell. If the target cell meets the first preset condition, the base station corresponding to the target cell will enter the energy saving state, and notify the user equipment of its synchronization signal block transmission mode under the energy saving state via the downlink control information. This realize the match between the network device's energy saving state and the user equipment's transmission or reception processing.

Referring to FIG. 10, in step S3, after the network device sends the second downlink information, the user equipment performs step S10: receiving the downlink information, which can specifically include step S102: receiving the second downlink information.

In an embodiment, the user equipment performs step S20, which may specifically include step S202: adjusting a receiving period of the synchronization signal block according to the period field and/or the energy indicator field in a received second downlink information.

In this embodiment, the user equipment can determine the energy consumption state of the network device according to the energy indicator field in the received second downlink information.

The second downlink information may include at least one of the following:
the energy indicator field for indicating the energy consumption state of the target cell;
the period field for indicating the transmission period of at least one synchronization signal block of the target cell;
the synchronization signal block index field for indicating the synchronization signal block index of the target cell.

In this embodiment, according to the second downlink information sent by the network device, the user equipment knows that the network device has restored to the normal state and the specific processing operation of the synchronization signal block under the normal state of the network device, so as to better transmit data service with the network device.

In an embodiment, the second downlink information can also be legacy physical downlink control information that does not contain the energy indicator field, the period field, or the synchronization signal block index field.

In an embodiment, if the second downlink information contains an energy indicator field, and the energy indicator field is set to 0, the synchronization signal block index field or period field may not exist.

In an embodiment, the user equipment can acquire the energy consumption state of the base station corresponding to the target cell only according to the energy indicator field.

In an embodiment, if the energy indicator field in the second downlink information is set to zero, it can be known that the base station will perform normal SSB transmission in the next SSB period according to configuration of the high-level parameter SSB-PositionsInBurst and the high-level parameter ssb-periodicityServingCell. For example, let the carrier frequency f meet: 3 GHz<f<=6 GHz, one SSB Burst set contains 8 candidate SSBs, the high-level parameter SSB-PositionsInBurst is set to ‘01101010’, and the high-level parameter ssb-periodicityServingCell is set to 20 ms. In the next SSB period, the base station will continue to transmit SS/PBCH block #2, SS/PBCH block #3, SS/PBCH block #5 and SS/PBCH block #7 according to the original period of 20 ms.

In an embodiment, the user equipment can acquire, according to whether the received second downlink information contains the energy indicator field, the energy consumption state of the base station corresponding to the target cell, and then acquire the actual transmission period of the synchronization signal block in the synchronization signal block burst set.

In an embodiment, if the second downlink information received by the user equipment does not contain the energy indicator field, the base station corresponding to the current target cell can be considered to be in a normal state. That is, the base station will perform normal SSB transmission according to the configuration of the high-level parameter SSB-PositionsInBurst and the high-level parameter ssb-periodicityServingCell.

In an embodiment, the user equipment can acquire, according to the energy indicator field and the synchronization signal block index field, the energy consumption state of the base station corresponding to the target cell, and then acquire the actual transmission period of the synchronization signal block in the synchronization signal block burst set.

In an embodiment, if the second downlink information received by the user equipment includes both the energy indicator field and the synchronization signal block index field, and if the energy indicator field is set to ‘1’ but the synchronization signal block index is different from the synchronization signal block index of the first downlink information, the user equipment can determine that although the base station is in a normal state, it only needs to restore the transmission of the beam direction corresponding to some synchronization signal blocks. For example, let the carrier frequency f meets: greater than the first frequency and less than or equal to the second frequency, the high-level parameter SSB-PositionsInBurst is set to ‘01101010’ and the high-level parameter ssb-periodicityServingCell is set to 20 ms.

In an embodiment, if the first preset condition is met, the base station corresponding to the target cell enters the energy saving state, and the energy indicator field in the first downlink information is set to ‘1’, and the synchronization signal block index is set to ‘0111’.

However, if the second preset condition is met, the base station corresponding to the target cell enters the normal state, and the energy indicator field in the first downlink information is set to ‘1’, and the synchronization signal block index is set to ‘0100’. According to the first downlink information and the second downlink information, the user equipment suspends the synchronization signal blocks SSB #3, SSB #5, and SSB #7 in the energy saving state. In the normal state, the normal transmission of SSB #5 and SSB #7 is only restored, and the SSB #3 is still suspended.

In an embodiment, according to the energy indicator field, period field and synchronization signal block index field, the user equipment can acquire the energy consumption state of the base station corresponding to the target cell, and acquire the actual transmission period of the synchronization signal block in the synchronization signal block burst set.

In an embodiment, if the second downlink information received by the user equipment includes both the energy indicator field and the synchronization signal block index field, and if the energy indicator field is set to ‘1’, but the synchronization signal block index is different from the synchronization signal block index of the first downlink information, the user equipment can determine that the base station is in a normal state but only needs to restore the transmission of the beam direction corresponding to some synchronization signal blocks. For example, when the carrier frequency f meets: greater than the first frequency and less than or equal to the second frequency, the high-level parameter SSB-PositionsInBurst is set to ‘01101010’ and the high-level parameter ssb-periodicityServingCell is set to 20 ms.

In an embodiment, if the first preset condition is met, the base station corresponding to the target cell enters the energy saving state, and the energy indicator field in the first downlink information is set to ‘1’, and the synchronization signal block index is set to ‘0111’, and the period field is set to 80 ms.

However, if the second preset condition is met, the base station corresponding to the target cell enters the normal state, and the energy indicator field in the first downlink information is set to ‘1’, the synchronization signal block index is set to ‘0100’, and the period field is set to 80 ms. Based on the first downlink information and the second downlink information, it can be observed that when the user equipment is in the energy saving state, the transmission period of the synchronization signal blocks SSB #3, SSB #5 and SSB #7 increases from 20 ms to 80 ms. When the user equipment is in the normal state, the periods of SSB #5 and SSB #7 are restored from 80 ms to 20 ms, while SSB #3 still maintains 80 ms for energy-saving transmission.

In an embodiment, the CRC-scrambled RNTI value of the first downlink information or the second downlink information can be a value different from the existing RNTI (Radio Network Temporary Identifier) value. For example, the RNTI of the first downlink information or the RNTI of the second downlink information is defined as SSB-RNTI and its value is any one of FFF3-FFFB. In an embodiment, FFF3 and FFFB are values representing by hexadecimal.

In an embodiment, the cyclic redundancy check (CRC) scrambled RNTI value of at least one of the first downlink information or the second downlink information can also be a RNTI value that has the same numeric value as the SI-RNTI (System Information Radio Network Temporary Identifier) or P-RNTI (Paging Radio Network Temporary Identifier).

In an embodiment, the first downlink information or the second downlink information can be an existing downlink control information format (DCI format). For example, the first downlink information or the second downlink information can be DCI format 1_0 etc.

In an embodiment, if the first downlink information or second downlink information is DCI format 1_0 and the system information radio-network temporary identification (SI-RNTI) is used for CRC scrambling, the energy indicator field, period field, and synchronization signal block index field in the downlink information can occupy the reserved bits in DCI format 1_0.

In an embodiment, if the first downlink information or the second downlink information is DCI format 1_0, and P-RNTI is used for CRC scrambling, the energy indicator field, period field, and synchronization signal block index field in the downlink information can be used for bit occupation according to the following scenarios:
if the short message indicator field in DCI format 1_0 is set to ‘10’ or ‘11’, the energy indicator field, period field, and synchronization signal block index field use reserved bits in the short message or other reserved bits in DCI format 1_0;
if the short message indicator field in DCI format 1_0 is set to ‘01’, the energy indicator field, period field, and synchronization signal block index field use 8 bits in the short message and other reserved bits in the DCI format 1_0.

In an embodiment, a search space set of the first downlink information or the second downlink information can adopt the same common search space set (CSS) as the SI-RNTI, for example, Type0-PDCCH CSS set, Type0A-PDCCH CSS set and so on.

In an embodiment, the search space set of the first downlink information or the second downlink information can adopt the same common search space set as the P-RNTI, for example, Type2-PDCCH CSS set, etc.

In an embodiment, the search space set of the first downlink information or second downlink information can adopt the common search space set corresponding to a newly defined RNTI value SSB-RNTI, for example, Type2A-PDCCH CSS set or Type3-PDCCH CSS set.

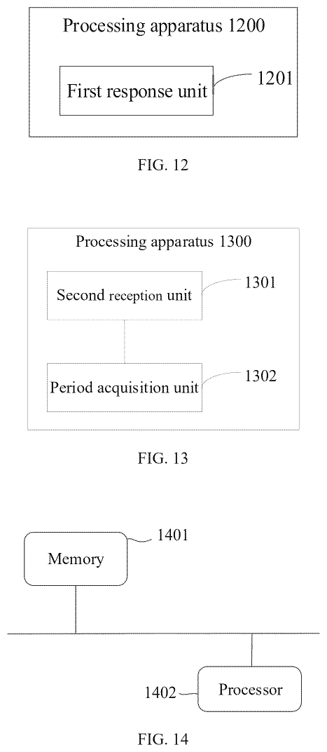

As shown in FIG. 12, which is a structural schematic diagram of an embodiment of a processing apparatus 1200 provided by an embodiment of the present disclosure, the processing apparatus may include:
a first response unit 1201, configured to respond to meeting a first preset condition, send first downlink information and enter an energy saving state.

As an embodiment, the first response unit may include at least one of the following:
a first detection module, configured for numbers of UEs camping in all beam directions of the synchronization signal block burst set in a target cell are all less than a first target threshold;
a second detection module, configured for numbers of data packets buffered for transmission and/or reception, in all beam directions of the synchronization signal block burst set in the target cell, are all less than a second target threshold, and/or, numbers of data transmission are all less than a third target threshold;
a third detection module, configured for a number of UEs camping in at least one beam direction of the synchronization signal block burst set in the target cell, is less than a fourth target threshold;
a fourth detection module, configured for a number of data packets buffered for transmission and/or reception, in at least one beam direction of the synchronization signal block burst set in the target cell, is less than a fifth target threshold, and/or, the number of data transmission is less than a sixth target threshold.

As an embodiment, the first response unit may include at least one of the following:
a first setting module, configured for a transmission period of at least one synchronization signal block in a synchronization signal block burst set of a target cell is increased to a target period, and a transmission period of at least one synchronization signal block in the synchronization signal block burst set of the target cell is unchanged;
a second setting module, configured for at least one synchronization signal block in a synchronization signal block burst set of the target cell is suspended and a transmission period of at least one synchronization signal block in the synchronization signal block burst set of the target cell is unchanged;
a third setting module, configured for all synchronization signal blocks in a synchronization signal block burst set of a target cell are suspended;
a fourth setting module, configured for transmission periods of all synchronization signal blocks in a synchronization signal block burst set of a target cell are increased to the target period.

As another embodiment, further including:
a first transmission unit, configured to send the first downlink information.

In an embodiment, the first downlink includes at least one of the following:
an energy indicator field for indicating an energy consumption state of a target cell; a period field for indicating a transmission period of at least one synchronization signal block of a target cell;
a synchronization signal block index field for indicating a synchronization signal block index of a target cell.

In an embodiment, a number of a first bit occupied by the synchronization signal block index field is equal to a number of a second bit set to 1 in an SSB-PositionsInBurst parameter.

As another embodiment, further including:
a first reception unit, configured to receive an uplink wake-up signal, the uplink wake-up signal is used for determining a number of UEs camping in at least one beam direction of a synchronization signal block burst set in a target cell.

As another embodiment, further including:
a second response unit, configured to enter a normal state according to the uplink wake-up signal and/or in response to meeting the second preset condition.

In an embodiment, the uplink wake-up signal includes at least one of the following:
a UE identification;
a specific synchronization signal block index;
a specific synchronization signal block period;
a preamble sequence;
a tracking reference signal sequence;
a DMRS-like sequence carried on a PUSCH.

In an embodiment, the second response unit, includes at least one of the following:
a first judgment module, configured for numbers of UEs camping in all beam directions of the synchronization signal block burst set in the target cell are all greater than or equal to the first target threshold;
a second judgment module, configured for numbers of data packets buffered for transmission and/or reception, in all beam directions of the synchronization signal block burst set in the target cell, are all greater than or equal to the second target threshold, and/or, numbers of data transmission are all greater than or equal to the third target threshold;
a third judgment module, configured for a number of UEs camping in at least one beam direction of the synchronization signal block burst set in the target cell, is greater than or equal to the fourth target threshold;
a fourth judgment module, configured for a number of data packets buffered for transmission and/or reception, in at least one beam direction of the synchronization signal block burst set in the target cell, is greater than or equal to the fifth target threshold, and/or, the number of data transmission is greater than or equal to the sixth target threshold.

In an embodiment, the second response unit, includes at least one of the following:
a first period module, configured for a transmission period of at least one synchronization signal block with bit set to 1 in target cell's SSB-PositionsInBurst parameter is consistent with a period configured by ssb-periodServingCell;
a second period module, configured for transmission periods of all the synchronization signal blocks with bit set to 1 in target cell's SSB-PositionsInBurst parameter are consistent with a period configured by ssb-periodServingCell.

As another embodiment, further including:
a second transmission unit, configured to send second downlink information.

In an embodiment, the target cell includes at least one of the following:
in carrier aggregation, a secondary cell whose TA value resides within the same Time Advance Group (TAG) as those of a primary cell;
in carrier aggregation, a secondary cell corresponding to a micro base station whose distance from a primary cell corresponding to a macro base station is less than a seventh target threshold;
a component carrier that does not carry downlink control information during cross-carrier scheduling in carrier aggregation;
a component carrier where the downlink control information resides during self-scheduling.

As shown in FIG. 13, which is a structural schematic diagram of an embodiment of a processing apparatus 1300 provided by an embodiment of the present disclosure, the processing apparatus may include:
a second reception unit 1301, configured to receive downlink information;
a period acquisition unit 1302, configured to acquire an actual transmission period of at least one synchronization signal block in a synchronization signal block burst set according to the downlink information.

As an embodiment, the period acquisition unit includes at least one of the following:
a first acquisition module, configured to acquire the actual transmission periods of all synchronization signal blocks in the synchronization signal block burst set according to an energy indicator field and a period field;
a second acquisition module, configured to acquire the actual transmission period of the at least one synchronization signal block in the synchronization signal block burst set according to an energy indicator field, a period field and a synchronization signal block index field;
a third acquisition module, configured to acquire the actual transmission period of the at least one synchronization signal block in the synchronization signal block burst set according to an energy indicator field and a synchronization signal block index field.

As another embodiment, further including:
an uplink transmission unit, configured to send an uplink wake-up signal in response to meeting a third preset condition, where the uplink wake-up signal is used for determining a number of UEs camping in at least one beam direction of the synchronization signal block burst set in a target cell.

In an embodiment, the uplink transmission unit includes at least one of the following:
a first transmission module, configured for reference signal receiving power of a SS/PBCH block measured by the user equipment in a current serving cell is lower than an eighth target threshold;
a second transmission module, configured for a cumulative number of events where UE's preamble transmission attempts reach a maximum number of transmission attempts in the current serving cell is greater than a ninth target threshold.

The apparatus of the embodiment of the present application can be used to perform the above processing method, and various steps and their technical effects are not described here.

FIG. 14 is a structure diagram of a communication device shown by an embodiment of the present application.

As shown in FIG. 14, the communication device provided by the embodiment includes:
a memory 1401;
a processor 1402; and,
a computer program.

In an embodiment, the computer program is stored in the memory 1401 and configured to be executed by the processor 1402 to implement the processing method as shown in any of the above embodiments.

The communication device shown in FIG. 14 may, for example, be a network device or a user equipment in the preceding embodiment.

The embodiment further provides a storage medium on which a computer program is stored,
the computer program is executed by a processor to implement the processing method as shown in any of the embodiments above.

The embodiments of the communication device and storage medium provided by the present application may include all technical features of any of the embodiments of the above processing method, and the contents of the specification expansion and interpretation are basically the same as those of the embodiments of the above method, and will not be repeated here.

An embodiment the present application also provides a computer program product, the computer program product includes computer program codes, when the computer program codes run on a computer, causes the computer to perform the method in various possible implementations above.

An embodiment the present application also provides a chip, including a memory and a processor, the memory is configured to store a computer program, and the processor is configured to invoke and run the computer program from the memory such that a device on which the chip is installed performs the method in various possible implementations above.

It can be understood that the above scenarios are only examples and do not constitute a limitation on application scenarios of the technical scheme provided by the embodiment of the present application, and the technical scheme of the present application can also be applied to other scenarios. For example, ordinary skilled persons in the art can know that with evolution of a system architecture and emergence of new service scenarios, the technical scheme provided by the embodiment of the present application is equally applicable to similar technical problems.

The above serial numbers of the embodiments of the present application are for description only and do not represent merits of embodiments.

The steps in the method of embodiments of the present application may be sequentially adjusted, combined and deleted according to actual needs.

The units of the device of the embodiment of the present application can be combined, divided and reduced according to actual needs.

In the present application, the same or similar term concepts, technical schemes and/or application scenarios are generally described in detail only when they first appear. When they are repeated later, they are generally not repeated for the sake of brevity. When understanding the technical schemes and other contents of the present application, for the same or similar terminology concepts, technical schemes and/or application scenarios that are not described in detail later, can refer to the relevant detailed descriptions before them.

In the present application, the description of each embodiment has its own weight. For the parts not detailed or recorded in one embodiment, refer to the relevant description of other embodiments.

The technical features of the technical scheme in the present application can be combined arbitrarily. For the sake of concise description, all possible combinations of the technical features in the above embodiments are not described. However, as long as there is no contradiction in the combination of these technical features, it should be considered as the scope of the record in the present application.

From the above description of implementations, it is clear to those skilled in the art that the above method embodiments can be implemented by means of software plus the necessary common hardware platform, and of course by hardware, but in many cases the former is the preferred implementation. Based on this understanding, the technical scheme of the present application in essence or the part that contributes to the prior art can be reflected in the form of a software product, which is stored in a storage medium (such as ROM/RAM, disk, optical disc), including several instructions for making a user equipment (which may be a mobile phone, computer, server, controlled terminal, or network device, etc.) perform method of each embodiment of the present application.

The above embodiment may be achieved in whole or in part by software, hardware, firmware, or any combination thereof. When implemented using software, it can be implemented in whole or in part in the form of a computer program product. The computer program product consists of one or more computer instructions. When computer program instructions are loaded and executed on a computer, all or some the processes or functions according to the embodiments of the present application are generated. The computer may be a general purpose computer, a special purpose computer, a computer network, or other programmable apparatus. The computer instructions can be stored in a storage medium or transmitted from one storage medium to another, for example, the computer instructions may be transmitted from one website site, computer, server, or data center via wired (e.g., coaxial cable, fiber optic, digital subscriber line) or wireless (e.g., infrared, wireless, microwave, etc.) to another website site, computer, server, or data center. The storage medium can be any available medium that a computer can access or a data storage apparatus such as a server or data center that contains one or more available medium. The available medium can be magnetic medium (e.g., floppy disk, storage disk, magnetic tape), optical media (e.g., DVD), or semiconductor medium (e.g., Solid State Disk (SSD)).

The above descriptions are only preferred embodiments of the present application and are not intended to limit the patent scope thereof. Equivalent structures or equivalent flow transformations made using the description and drawings of the present application, or direct or indirect applications in other related technical fields, are all equally included in the patent protection scope of the present application.

1-17. (canceled)

18. A processing method, comprising:
S1: sending first downlink information and entering an energy saving state.

19. The method according to claim 18, wherein the energy saving state, comprises at least one of the following:
a transmission period of at least one synchronization signal block in a synchronization signal block burst set of the target cell is increased to a target period, and the transmission period of at least one synchronization signal block in the synchronization signal block burst set of the target cell is unchanged;
at least one synchronization signal block in the synchronization signal block burst set of the target cell is suspended and the transmission period of at least one synchronization signal block in the synchronization signal block burst set of the target cell is unchanged;
all synchronization signal blocks in the synchronization signal block burst set of the target cell are suspended; and
transmission periods of all synchronization signal blocks in the synchronization signal block burst set of the target cell are increased to a target period.

20. The method according to claim 18, wherein the first downlink information comprises at least one of the following:
an energy indicator field for indicating an energy consumption state of the target cell;
a period field for indicating a transmission period of at least one synchronization signal block of the target cell; and
a synchronization signal block index field for indicating a synchronization signal block index of the target cell.

21. The method according to claim 20, wherein a number of a first bit occupied by the synchronization signal block index field is equal to a number of a second bit set to 1 in an SSB-PositionsInBurst parameter.

22. The method according to claim 18, further comprising:
S3: sending second downlink information and entering a normal state.

23. The method according to claim 22, wherein entering the normal state, comprises at least one of the following:
a transmission period of at least one synchronization signal block with bit set to 1 in target cell's SSB-PositionsInBurst parameter is consistent with a period configured by ssb-periodServingCell;
transmission periods of all the synchronization signal blocks with bit set to 1 in the target cell's SSB-PositionsInBurst parameter are consistent with a period configured by the ssb-periodServingCell.

24. The method according to claim 23, wherein the target cell comprises at least one of the following:
in carrier aggregation, a secondary cell whose Time Advance (TA) value resides within the same Time Advance Group (TAG) as those of a primary cell;
in the carrier aggregation, a secondary cell corresponding to a micro base station whose distance from a primary cell corresponding to a macro base station is less than a seventh target threshold;
a component carrier that does not carry downlink control information during cross-carrier scheduling in carrier aggregation; and
a component carrier where the downlink control information resides during self-scheduling.

25. A processing method, comprising following steps:
S101: receiving first downlink information; and
S201: acquiring a transmission period of at least one synchronization signal block in a synchronization signal block burst set of a target cell according to the first downlink information.

26. A communication device, comprising:
a memory; and
a processor;
wherein the memory stores a computer program, when the computer program is executed by the processor, the processing method according to claim 18 is implemented.

27. A non-transitory storage medium, the non-transitory storage medium stores a computer program, when the computer program is executed by a processor, the processing method according to claim 18 is implemented.

28. The method according to claim 19, wherein the transmission period of at least one synchronization signal block in the synchronization signal block burst set of the target cell comprises at least one of 5 ms, 10 ms, 20 ms, 40 ms, 80 ms and 160 ms.

29. The method according to claim 25, wherein the first downlink information comprises at least one of the following:
an energy indicator field for indicating an energy consumption state of the target cell;
a period field for indicating a transmission period of at least one synchronization signal block of the target cell; and
a synchronization signal block index field for indicating a synchronization signal block index of the target cell.

30. The method according to claim 29, wherein a number of a first bit occupied by the synchronization signal block index field is equal to a number of a second bit set to 1 in an SSB-PositionsInBurst parameter.

31. The method according to claim 25, wherein the transmission period of at least one synchronization signal block in the synchronization signal block burst set of the target cell comprises at least one of 5 ms, 10 ms, 20 ms, 40 ms, 80 ms and 160 ms.

32. The method according to claim 31, further comprising:
S102: receiving second downlink information; and
S202: adjusting a receiving period of a synchronization signal block according to a period field and/or an energy indicator field in the second downlink information.

33. The method according to claim 25, wherein the target cell comprises at least one of the following:
in carrier aggregation, a secondary cell whose Time Advance (TA) value resides within the same Time Advance Group (TAG) as those of a primary cell;
in the carrier aggregation, a secondary cell corresponding to a micro base station whose distance from a primary cell corresponding to a macro base station is less than a seventh target threshold;
a component carrier that does not carry downlink control information during cross-carrier scheduling in carrier aggregation; and
a component carrier where the downlink control information resides during self-scheduling.
